(19) United States
(12) Patent Application Publication
(10) Pub. No.: US 2013/0144784 A1
(43) Pub. Date: Jun. 6, 2013

(54) Security Component for Electronic Commercial Activity

(71) Applicants: Lin Yang, Shanghai (CN); Qi Xue, Shanghai (CN); Tianxiang Chen, Shanghai (CN); Kurt Alan Weber, Seattle, WA (US)

(72) Inventors: Lin Yang, Shanghai (CN); Qi Xue, Shanghai (CN); Tianxiang Chen, Shanghai (CN); Kurt Alan Weber, Seattle, WA (US)

(73) Assignee: MICROSOFT CORPORATION, Redmond, WA (US)

(21) Appl. No.: 13/309,823

(22) Filed: Dec. 2, 2011

(51) Int. Cl. G06Q 20/40

(52) U.S. Cl. 705/44

(57) ABSTRACT

The subject disclosure is directed towards securing electronic commercial activity. Geo-locations are determined for one Internet transaction and another Internet transaction. These Internet transactions are related based on a common credential. Using timestamps, a relative travel speed between the geo-locations is computed for the Internet transaction and the other Internet transaction. Based upon the relative travel speed, a security component may invalidate the Internet transaction and/or the other Internet transaction.

### BACKGROUND

There are a number of consumer-to-consumer (c2c) Internet forums that enable online trading and transactions between individual buyers and sellers. Unfortunately, such forums have become institutions for individuals (“fraudsters”) who engage in fraudulent activity with a known electronic commercial activity platform (e.g., MICROSOFT® XBox™ Live). These forums cross international borders and often employ various techniques that circumvent mechanisms for detecting the fraudulent activity.

In part due to a lack of oversight from local, national or international governing bodies (e.g., law enforcement), these forums have contributed to a significant revenue loss for legitimate companies. Fraudsters compromise legitimate user accounts or create fraudulent accounts using another person's confidential information (e.g., a credit card number). After fraudulently purchasing electronic assets (e.g., MICROSOFT® XBox™ Live Points) for these accounts, the fraudster uses these forums to offer these accounts for sale to highest bidders. When a person buys one of these accounts, he/she proceeds to redeem the electronic assets for physical and/or virtual goods (e.g., content, software and/or the like), which may be later sold or traded to another account holder for a considerable profit. By the time the fraudulent purchases are identified and victims made whole, the electronic assets have already been redeemed for goods and/or services, which causes a revenue loss for providers of these goods and/or services.

Conventional mechanisms for securing legitimate user accounts and confidential information are not efficient. For example, simply determining whether respective Internet Protocol (IP) addresses associated with an electronic asset purchase and redemption are identical does not work when the IP addresses are dynamic-assigned. Another mechanism uses IP address reverse lookup information, and compares a geo-location of the IP address with a billing address. Inaccuracies associated with the IP address reverse lookup information, however, causes many false positives, which occur when fraudulent activity is incorrectly detected because a legitimate user is not currently at a location that matches the legitimate user's billing address.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards securing electronic commercial activity from fraudulent misappropriation. In one aspect, a security component identifies two or more related Internet transactions with an electronic commercial activity platform. One Internet transaction is related to another Internet transaction when these transactions have a common credential, such as a common user/account identifier.

If a location associated with the one Internet transaction differs from a location associated with the other Internet transaction, and the transactions are close together in time, there is a possibility that the same person may not have performed both transactions, because he or she cannot have traveled between those locations given the close time difference. In one aspect, by computing a relative travel speed between these locations, the security component may detect such a situation, and invalidate one or both Internet transactions if the relative travel speed exceeds a pre-defined threshold. If the relative travel speed is low enough for the person to have traveled between these locations, the security component allows the transactions to continue, typically passing the transaction to another security component for further evaluation.

In one aspect, these Internet transactions may include an electronic asset purchase transaction and a subsequent electronic asset redemption transaction. If a fraudster compromises a pre-existing account that is registered with the electronic commercial activity platform or creates a fraudulent account using misappropriated confidential information, the fraudster may fraudulently purchase and load either account with electronic assets. When a buyer of the electronic assets submits the redemption transaction, the security component determines geo-locations associated with the purchase transaction and the redemption transaction and uses timestamps to compute the relative travel speed between the geo-locations. In one aspect, the relative travel speed is a quotient of a geo-distance between the geo-locations over a time difference between the purchase transaction and the redemption transaction. If it is impractical for a valid user to travel at the relative travel speed, the security component invalidates the redemption transaction, and for example may delete or freeze the account.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary system for securing electronic commercial activity between a plurality of computers according to one example implementation.

FIG. 2 is an exemplary representation of the Earth that is suitable for performing geo-distance computations according to one example implementation.

FIG. 3 is a flow diagram illustrating exemplary steps for securing electronic commercial activity between a plurality of computers according to an example implementation.

FIG. 4 is a flow diagram illustrating exemplary steps for using a relative travel speed between two Internet transactions at different geo-locations to verify an account according to an example implementation.

FIG. 5 is a block diagram representing exemplary non-limiting networked environments in which various embodiments described herein can be implemented.

FIG. 6 is a block diagram representing an exemplary non-limiting computing system or operating environment in which one or more aspects of various embodiments described herein can be implemented.

### DETAILED DESCRIPTION

Various aspects of the technology described herein are generally directed towards a security component for detecting fraudulent electronic commercial activity. In general, by computing a relative travel speed that indicates how fast a person needs to travel between locations associated with two related Internet transactions, the security component determines the likelihood that the person may have conducted these transactions.

In one exemplary implementation, the security component forms a portion of a legitimate electronic commercial activity platform through which legitimate users purchase and redeem electronic assets. There is a reasonable likelihood that a legitimate user validly executed an electronic asset purchase and a subsequent redemption if the relative travel speed between purchase and redemption locations falls below a pre-defined threshold. When the relative travel speed exceeds a pre-defined threshold, then there is a strong likelihood that the legitimate user did not perform one or both these transactions. In response to such a relative travel speed, the security component may invalidate the electronic asset redemption and/or the electronic asset purchase.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and fraud detection in general.

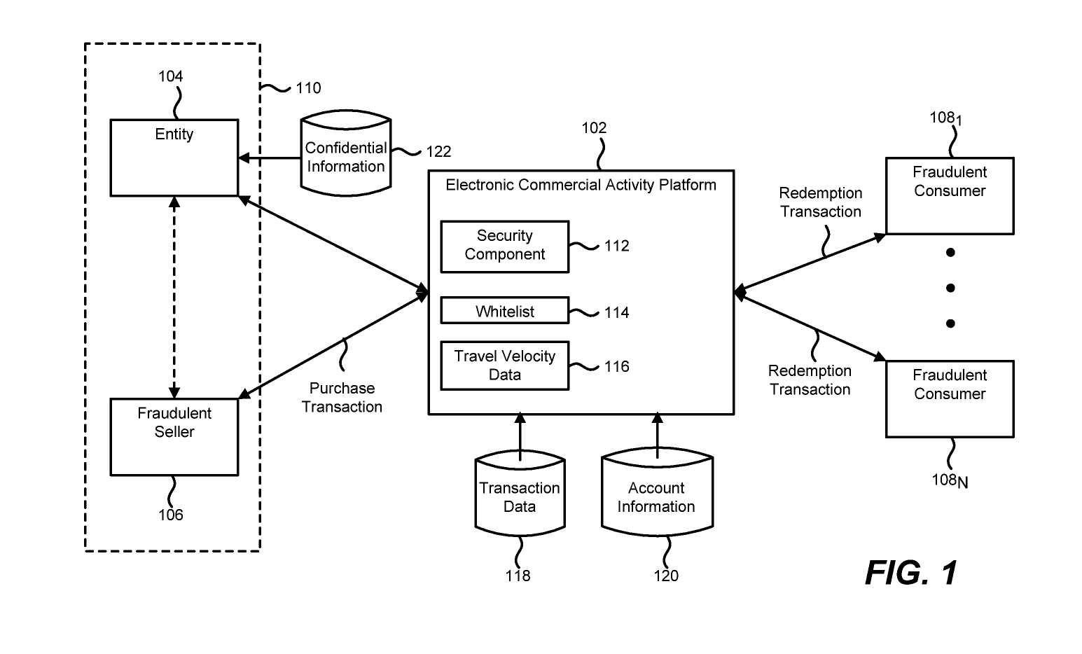

FIG. 1 is a block diagram illustrating an exemplary system for securing electronic commercial activity between a plurality of computers according to an example implementation. Exemplary components of such a system include an electronic commercial activity platform 102, an entity 104, a fraudulent seller 106 and a plurality of fraudulent consumers 108.

The entity 104 and the fraudulent seller 106 may include computers that co-locate in a particular geo-location 110. Alternatively, the entity 104 and the fraudulent seller 106 may be located in different geo-locations. In yet another alternative implementation, the fraudulent seller 106 may be located in another geo-location and use a proxy computer within the particular geo-location 110 when conducting fraudulent commercial activity. The plurality of fraudulent consumers 108 includes computers that occupy a different geo-location from the entity 104.

In one exemplary implementation, the electronic commercial activity platform 102 includes a security component 112, a whitelist 114 and travel speed data 116 and accesses various databases, such as transaction data 118 and account information 120. As described herein, the security component 112 detects fraudulent electronic commercial activity between the fraudulent seller 106 and the fraudulent consumers 108. The whitelist 114 comprises one or more Internet Protocol (IP) addresses that are verified as safe and known to be associated with credible account holders. The travel speed data 116 may include relative travel speeds associated with Internet transactions that originated in different geo-locations as well as one or more threshold values, which are compared with the relative travel speeds. As also described herein, the travel speed data 116 may be used to invalidate Internet transactions. For each Internet transaction, the transaction data 118 may indicate an IP address, a timestamp, one or more credentials (e.g., a user/account identity, a credit card number and/or the like), an electronic asset purchase/redemption amount and/or the like.

In one exemplary implementation, the security component 112 accesses transaction data 118 and identifies one or more groups of related Internet transactions in which each group may have a common credential. Two or more Internet transactions associated with a particular electronic asset amount may, for example, include a purchase transaction and/or one or more redemption transactions using a same identifier (i.e., product SKU), a same user/account identity (i.e., a GamerTag or a Passport Unique ID (PUID)) and/or a same debit/credit card number.

Typically, within a relatively short time period after execution of the purchase transaction by the fraudulent seller 106, one of the fraudulent consumers 108 acquires the particular electronic asset amount and submits the redemption transaction to the electronic commercial activity platform 102. By computing a relative travel speed between a purchase transaction location, such as the geo-location 110, and a redemption transaction location, the security component 112 may determine whether it is implausible for a person move at that rate and make both transactions. For example, if the relative travel speed exceeds a pre-defined threshold, then it is unlikely that the person is able to cover such a distance in the relatively short time period and the security component 112 automatically invalidates the redemption transaction.

The account information 120 includes details associated with each registered account of the electronic commercial activity platform 102, such as various credentials, an electronic asset balance/entitlement, transaction history and/or the like, according to one exemplary implementation. The credentials stored for each account may include, for example, a debit/credit card number, a gift card number, various identifiers (e.g., MICROSOFT® .NET Passport Unique ID (PUID) and/or a device-based unique ID), a user identity (e.g., a user/account name, such as a MICROSOFT® Xbox™ Gamertag or a Passport/Windows Live ID), an email address, a password and/or the like. The credentials may also include signatures for identifying individual ones of the electronic asset balance. The electronic asset balance, as an example, may refer to virtual points that hold a certain fair market value in the electronic commercial activity platform 102. These points may be traded to other account holders and/or redeemed for physical or virtual goods/services.

Confidential information 122 includes various personal data that enables the entity 104 to conduct secure commercial or financial transactions (i.e., purchases) with another entity (e.g., merchants). For example, the confidential information 122 may store various private numerical data, such as a credit/debit card number, a checking account number, a social security number and/or the like, including any related verification data, such as a security code for the credit card number, a personal identification number (PIN) for the checking account number, a birth date for the social security number and/or the like.

The confidential information 122 may also include security information for accessing various online accounts via the Internet, such as a login/username, a password and/or security question answers for an online bank account or e-commerce account (e.g., an online auction account, an electronic funds transfer account, a digital current account and/or the like). As another example, the security information may include an e-mail address and password for an Internet property (e.g., an online multiplayer game account, a social networking platform and/or the like).

In one exemplary implementation, the fraudulent seller 106 surreptitiously attains access to the confidential information 122 and comprises certain personal data for the entity 104, which is used to illegitimately purchase electronic assets. The fraudulent seller 106 may also create a fraudulent account within the electronic commercial activity platform 102 to manage the electronic assets, but these purchases may be accomplished without the fraudulent account. For example, the fraudulent seller 106 may use a third-party online store for maintaining the electronic assets. The electronic assets, with or without the fraudulent account, are sold to one or more of the fraudulent consumers 108 who attempt to use the electronic assets to obtain physical and/or virtual goods and/or services from the electronic commercial activity platform 102 and/or another similar platform. As an example, the fraudulent consumer may desire gaming content, software and/or systems as well as strategy publications, character enhancements, rewards and/or hidden content for a specific game.

For example, the fraudulent seller 106 may acquire a credit card number and a security code belonging to the entity 104 from the account information 120, from the confidential information 122 or by buying this information from another fraudster. Then, the fraudulent seller 106 using the credit card data loads a MICROSOFT® Xbox™ Live account with as many points as possible (after creating a new account if one did not previously exist). Subsequently, the fraudulent seller 106 offers such an account for sale on an online trading forum on which such an account is bought by a highest bidder amongst the fraudulent consumers 108.

As described herein, before the buyer of the MICROSOFT® Xbox™ Live account redeems the points for various goods and services, the electronic commercial activity platform 102 evaluates this potential transaction for fraud. To this end, assuming that the fraudulent consumer 108 inhabits a different geo-location from the entity 104 and/or the fraudulent seller 106, a relative travel speed between those locations may be too large to be practical, which indicates likely fraudulent electronic commercial activity (i.e., a fraudulent or compromised account sale and/or electronic asset sale).

As described herein, in order to frustrate an illegal marketplace for such fraudulent electronic commercial activity, the security component 112 computes a geo-distance between a geo-location associated with the fraudulent consumer 108 at the time of redemption and a geo-location associated with the fraudulent seller 106 at the time of the fraudulent purchase. Then, the security component 112 computes the relative travel speed. In one exemplary implementation, this comprises a quotient (i.e., a ratio) of the geo-distance and a time difference between the purchase transaction and the redemption transaction. If the relative travel speed exceeds a pre-defined threshold, the security component 112 invalidates the redemption transaction and may delete or freeze the fraudulent account; otherwise, the security component 112 allows the redemption transaction to continue. For example, the security component 112 may pass the redemption transaction to another security barrier. As an alternative, the security component 112 may monitor the fraudulent account for additional indicia of the fraudulent electronic commercial activity.

As another example, consider that the entity 104 conducts legitimate Internet transactions with the electronic commercial activity platform 102 as a valid user. At some point, the fraudulent seller 106 uses various credentials and/or personal data to compromise a pre-existing account corresponding with the entity 104 and misappropriates available electronic assets, which are traded/sold to one or more of the fraudulent consumers 108, with or without the compromised account. The fraudulent seller 106 may also use the compromised account to purchase additional electronic assets to be sold to a highest bidder. When a buyer attempts to redeem any of these electronic assets, the security component 112 computes a relative travel speed to determine whether it is unlikely that the entity 104 was able to travel from a purchase location to a redemption location. If the relative travel speed exceeds a pre-defined threshold, there is a strong likelihood that a fraudster compromised the account of the entity 104.

Alternatively, after compromising the account of the entity 104, the fraudulent seller 106 uses a proxy server to transfer electronic assets to another account. Because the proxy server and the entity 104 are co-located, when the fraudulent seller 106 or the fraudulent consumer 108 who bought the other account attempts to redeem the electronic assets, the security component 112 computes the relative travel speed and determines whether it is reasonably possible for the entity 104 to have traveled between the purchase location and the redemption location. If the relative travel speed exceeds the pre-defined threshold, the security component 112 invalidates the redemption transaction.

In another exemplary implementation, the fraudulent seller 106 uses the credentials of the entity 104 to create one or more fraudulent accounts for which electronic assets are purchased. Some of these fraudulent accounts may falsely identify an owner in order to take undue credit for goodwill attained by the entity 104. For example, an account owned by the entity 104 may be entitled to certain privileges or benefits due to a high reputational value. The fraudulent seller 106 offers the one or more fraudulent accounts for sale on an illegal market where the fraudulent consumers 108 buy these accounts. An automated computer program (i.e., a BOT) may perform the creation and sale of these accounts.

In yet another exemplary implementation, the security component 112 computes a relative travel speed between two of the fraudulent consumers 108 if the geo-location 110 cannot be determined for the fraudulent seller 106. For instance, consider that the two fraudulent consumers 108 submitted redemption transactions that correspond to one or more fraudulent purchase transactions made by the fraudulent seller 106 for which an IP address reverse lookup operation failed to produce an accurate geo-location. If the relative travel speed between geo-locations associated with the two fraudulent consumers 108 exceeds the pre-defined threshold, the security component 112 invalidates the redemption transactions and deletes or freezes the fraudulent account. Alternatively, the security component 112 monitors fraudulent activity initiated by the fraudulent account.

According to another implementation, the security component 112 uses the whitelist 114 to verify Internet transaction invalidations based on the travel speed data 116. If a blocked Internet transaction IP address matches an IP address within the whitelist 114, the security component 112 reverses the preceding invalidation and permits execution of the blocked Internet transaction. The security component 112 may also adjust the threshold value to mitigate such a false positive. As an alternative, if an IP address associated a pending electronic asset redemption transaction matches one of the IP addresses within the whitelist 114, the security component 112 permits such a transaction to continue to another security component even though the relative travel velocity exceeds the threshold.

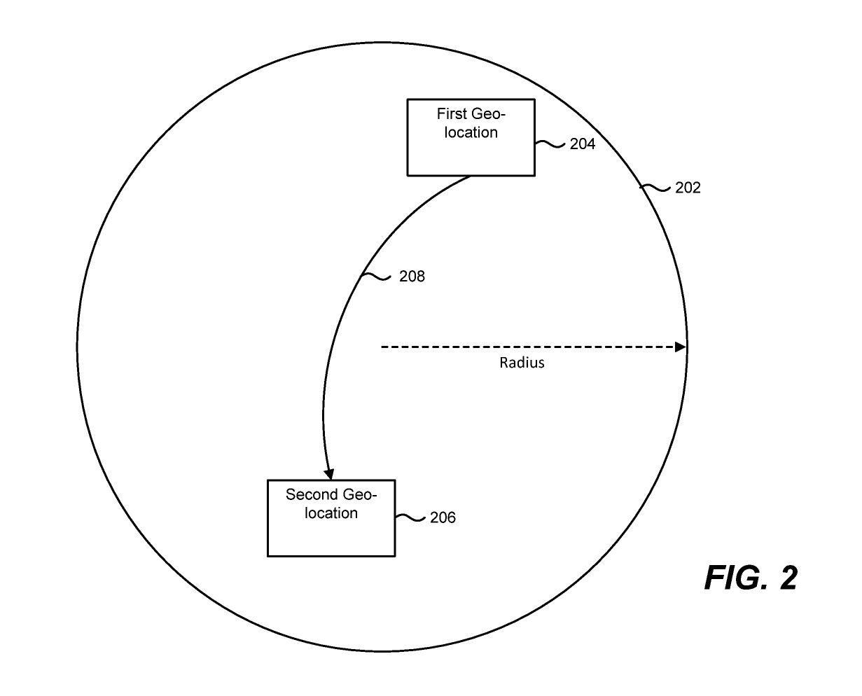

FIG. 2 is an exemplary representation of Earth 202 that is suitable for performing geo-distance computations according to one example implementation. Computers within a first geo-location 204 and a second geo-location 206 submitted an Internet transaction and another Internet transaction having a common credential, respectively. Each of the first geo-location 204 and the second geo-location 206 may refer to a real-world geographic location of a specific computer. The first geo-location 204 and/or the second geo-location 206 may vary with respect to precision. For example, an exemplary geo-location may be a set of coordinates (e.g., latitude, longitude and/or elevation with respect to reference ellipsoid), a well-defined area (e.g., a timezone) or a portion of an address (e.g., a city and/or state, street name or a zipcode).

In one exemplary implementation, each of these Internet transactions includes with a time-stamp as well as a longitude and latitude. The longitude and latitude may refer to the first geo-location 204 and the second geo-location 206 or to actual locations of the computers from which the internet transactions originated. In one exemplary implementation, a relative travel speed 208 between the first geo-location 204 and the second geo-location 206 with respect to the Internet transactions is computed using the following expression:

$$Radius \times \frac{{cos}^{- 1} ( \begin{matrix}sin latitude 1 \times sin latitude 2 + cos latitude 1 \times \\ cos latitude 2 \times cos ( longitude 1 - longitude 2 )\end{matrix} )}{abs ( timestamp 1 - timestamp 2 )}$$

According to the above expression, latitude1 and longitude1 refer to the latitude and longitude (in radians) of the first geo-location 204. Timestamp1 refers to a time at which the Internet transaction originated from first geo-location 204. Similarly, latitude2 and longitude2 refer to the second geo-location 206 and Timestamp2 refers to a time at which the other Internet transaction originated from the second geo-location 206. Radius refers to the radius of the earth in miles or kilometers (e.g., six-thousand three hundred and seventy-one (6371) km). If kilometers are used, an example relative travel speed 208 may be in terms of kilometers per hour (km/h). Alternative implementations of the above-mentioned expression may utilize various other (geographic) coordinate systems, such as three-dimensional Cartesian coordinates, spherical coordinates, other types of geodetic coordinates (e.g., Universal Transverse Mercator coordinates) and/or the like, instead of longitude and latitude values when computing the relative travel speed 208.

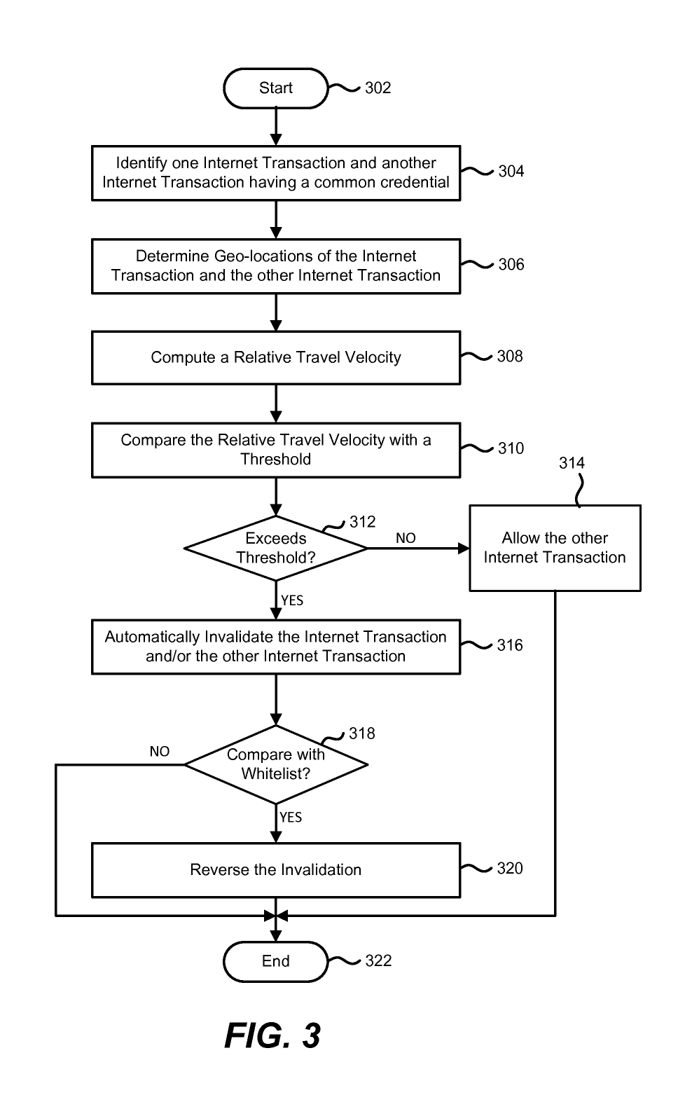

FIG. 3 is a flow diagram illustrating exemplary steps for securing electronic commercial activity between a plurality of computers according to an example implementation. Steps depicted in FIG. 3 commence at step 302 and proceed to step 304 when the security component 112 identifies an Internet transaction and another Internet transaction having a common credential. For example, two Internet transactions that share a user identity or an account identifier may be related, such as an electronic asset purchase and a subsequent electronic asset redemption for a particular account.

Step 306 is directed to determining geo-locations of the Internet transaction and the other Internet transaction. In one exemplary implementation, the security component 112 may employ well-known techniques for determining the geo-locations. Such techniques (e.g., IP reverse lookup) may match an IP address associated with either Internet transaction with known IP address and geo-location pairings.

Step 308 is directed to computing a relative travel speed between the geo-locations. In one exemplary implementation, the security component 112 determines a geo-distance (i.e., geographic distance) between the geo-location associated with the Internet transaction and the geo-location associated with the other Internet transaction. By dividing the geo-distance with a time difference between the Internet transaction and the other Internet transaction, a relative travel speed is computed. Such a time difference is computed as an absolute value.

Step 310 represents a comparison of the relative travel speed with a threshold. Step 312 is directed to a determination as to whether the relative travel speed exceeds the threshold. If the relative travel speed falls below the threshold, the steps described in FIG. 3 proceeds to step 314. Step 314 is directed to allowing the other Internet transaction. After performing step 314, the steps described in FIG. 3 proceeds to step 322. If the relative travel speed exceeds the threshold, the steps described in FIG. 3 proceeds to step 316. Hence, it is most likely implausible for a person to move at the relative travel speed between a location at the time of the Internet transaction and a location at the time of the other Internet transaction. Step 316 is directed to automatically invalidating the Internet transaction and/or the other Internet transaction.

Step 318 is directed to a comparison of the other Internet transaction with a whitelist. If the whitelist comprises an IP address associated with the other Internet transaction, the steps described in FIG. 3 proceeds to step 320. Step 320 refers to reversing the invalidation. If the whitelist does not comprise such an IP address, the steps described in FIG. 3 proceeds to step 322. Step 322 terminates the steps described in FIG. 3.

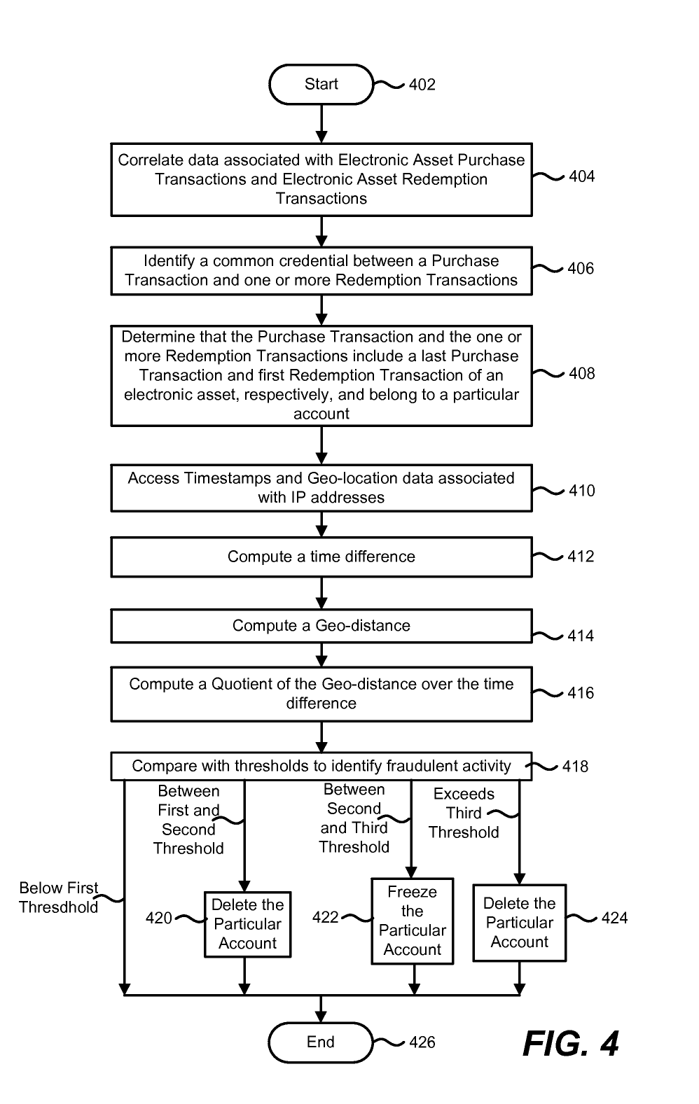

FIG. 4 is a flow diagram illustrating exemplary steps for using a relative travel speed between two or more Internet transactions at different geo-locations to verify an account according to an example implementation. These steps may form a retroactive security measure that is performed after these Internet transactions were completed by an electronic commercial activity platform. Steps depicted in FIG. 4 commence at step 402 and proceed to step 404 when the security component 112 correlates data associated with electronic asset purchase transactions and electronic asset redemption transactions.

Step 406 refers to identifying a common credential between a purchase transaction and one or more redemption transactions. Sharing the common credential, such as an account name, indicates that a relationship between these transactions. Step 408 represents determining identifying that the purchase transaction and the one or more redemption transactions include a last purchase transaction and a first redemption transaction of an electronic asset, respectively, and belong to a particular account. The last purchase transaction refers to a most recent purchase of electronic assets. If there is a plurality of redemption transactions, then one or more subsequent redemption transactions occurred after the first redemption transaction. Step 410 is directed to accessing timestamps of the last purchase transaction and the one or more redemption transactions and geo-location data associated with IP addresses.

Step 412 is directed to computing a time difference between timestamps. For example, a time difference between a last purchase transaction timestamp and a first redemption transaction timestamp may be computed. As an alternative, a time difference between two redemption transaction timestamps may be computed if a geo-location for the last purchase transaction cannot be determined. Step 414 is directed to computing a geo-distance. For example, a geo-distance between a last purchase transaction geo-location and a first redemption transaction geo-location may be computed. As another example, a geo-distance between a first purchase transaction geo-location and a second redemption transaction geo-location may be computed. Step 416 is directed to computing a quotient of the geo-distance over the time difference. The quotient is used as a relative travel speed between the geo-locations.

Step 418 decides whether there is fraudulent activity associated with the particular account. In one exemplary implementation, to determine whether a person who initiated the last purchase transaction had to travel too fast to have initiated the first redemption transaction and/or any subsequent redemption transaction, the security component 112 compares the relative travel speed to a plurality of thresholds. For example, a first threshold may indicate a statistically rare or a near-unattainable speed (i.e., a top speed) by known ground/sea transportation technology, a second threshold may refer to an average airplane speed and a third threshold may indicate a speed that is prohibited by known transportation technology.

If the relative travel speed is between the first and second threshold, the steps described in FIG. 4 proceeds to step 420 at which the particular account is monitored for indicia of fraudulent activity in future transactions. If the relative travel speed exceeds the second threshold, the steps described in FIG. 4 proceeds to step 422 at which the particular account is frozen until the one or more transactions may be verified. If the relative travel speed exceeds the third threshold, then it is unlikely that a person is able to move at such a rate and the steps described in FIG. 4 proceeds to step 424 at which the particular account is deleted. If the relative travel speed falls below the first threshold, the steps described in FIG. 4 proceed to Step 426. Step 426 is directed to terminating the steps described in FIG. 4.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

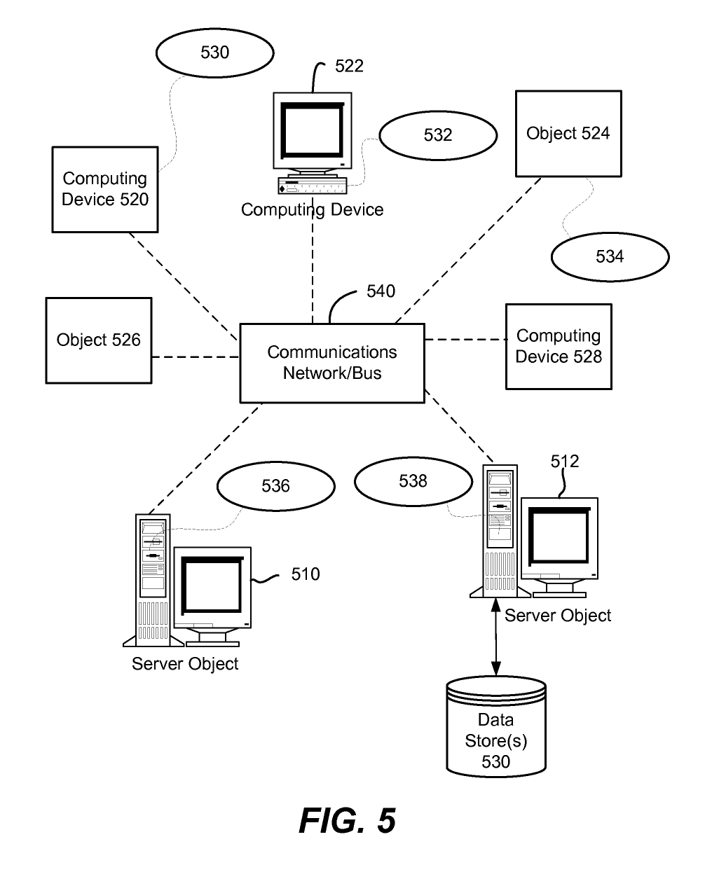

FIG. 5 provides a schematic diagram of an exemplary networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Exemplary Computing Device

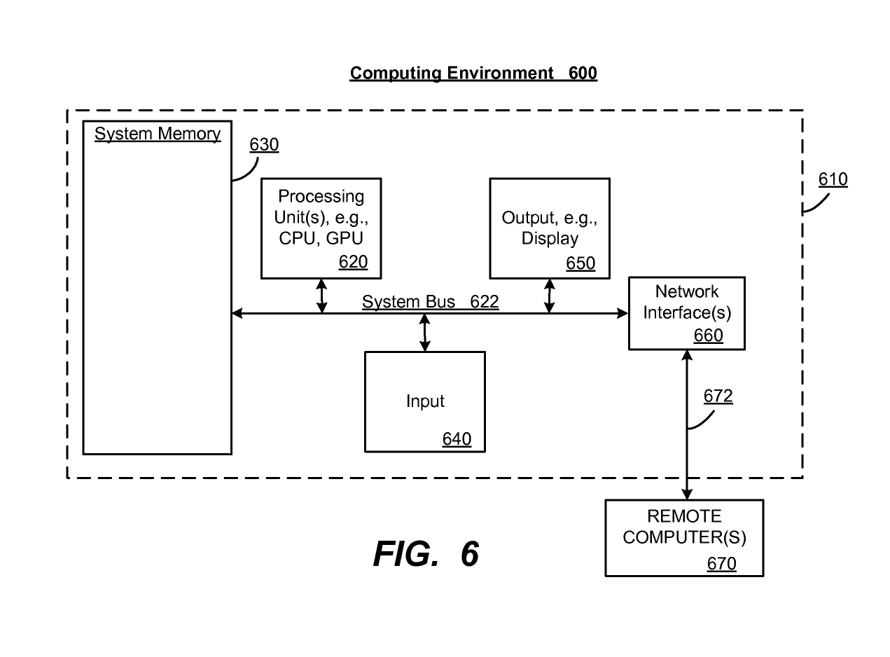

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the exemplary computing system environment 600.

With reference to FIG. 6, an exemplary remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, securing electronic commercial activity between a plurality of computers, including determining respective geo-locations associated with one Internet transaction that is related to another Internet transaction, computing a relative travel speed between the respective geo-locations using timestamps, and automatically invalidating at least one of the Internet transaction and the other Internet transaction in response to the relative travel speed.

2. The method of claim 1, wherein computing the relative travel speed further comprises computing a geo-distance between the geo-locations and computing a quotient of the geo-distance over a time difference between the timestamps.

3. The method of claim 1, wherein the one Internet transaction comprises a last purchase transaction of an electronic asset for a particular account and the other Internet transaction comprises a first redemption transaction of the electronic asset.

4. The method of claim 1 further comprising correlating data associated with electronic asset purchase transactions and electronic asset redemption transactions.

5. The method of claim 4 further comprising identifying a common credential between a purchase transaction and one or more redemption transactions.

6. The method of claim 5 further comprising using the relative travel speed between a first redemption transaction and a second redemption transaction to identify one or more fraudulent accounts.

7. The method of claim 5 further comprising identifying a compromised account based on the common credential.

8. The method of claim 5 further comprising identifying a fraudulent account based on the common credential, wherein the fraudulent account is created by a fraudster using confidential information of an entity.

9. The method of claim 1, wherein automatically invalidating the at least one of the Internet transaction and the other Internet transaction further comprises monitoring an account associated with the other Internet transaction if the relative travel speed exceeds a pre-defined threshold value.

10. The method of claim 1 further comprising reversing the invalidating of at least one of the Internet transaction and the other Internet transaction based on a whitelist comprising verified Internet Protocol addresses.

11. In a computing environment, a system, comprising, a security component configured to detect fraudulent electronic commercial activity, wherein the security component is further configured to identify a last purchase transaction of an electronic asset that corresponds with a first redemption transaction having a common credential, determine geo-locations associated with the last purchase transaction and the first redemption transaction, the security component configured to use a relative travel speed computed based upon the last purchase transaction at a first timestamp and the first redemption transaction at a second timestamp to determine whether to invalidate the first redemption transaction.

12. The system of claim 11, wherein the security component is configured to compute a geo-distance between the geo-locations, and to compute the relative travel speed using a quotient of the geo-distance over a difference between the first timestamp and the second timestamp.

13. The system of claim 11, wherein the security component is further configured to reverse the invalidating of the first redemption transaction based on a whitelist comprising verified Internet Protocol addresses.

14. The system of claim 11, wherein the security component is further configured to deletes an account associated with the first redemption transaction if the relative travel speed exceeds a pre-defined threshold value.

15. The system of claim 11, wherein the security component is further configured to freeze an account associated with the first redemption transaction if the relative travel speed falls below a pre-defined threshold value.

16. The system of claim 11, wherein the security component is further configured to identify a fraudulent account associated with the first redemption transaction based upon a common credential associated with the first redemption transaction and the last purchase transaction.

17. The system of claim 16, wherein the security component monitors the fraudulent account.

18. One or more computer-readable media having computer-executable instructions, which when executed perform steps, comprising:
identifying related Internet transactions associated with an electronic asset and a common credential;
determining geo-locations associated with the Internet transactions; and
if a relative travel speed between the geo-locations, computed using timestamps associated with the Internet transactions, exceeds a first pre-defined threshold, blocking at least one of the Internet transactions for fraudulent electronic commercial activity.

19. The one or more computer-readable media of claim 18 having further computer-executable instructions comprising:
deleting an account associated with the Internet transactions if the relative travel speed exceeds a second pre-defined threshold value.

20. The one or more computer-readable media of claim 18 having further computer-executable instructions comprising:
identifying a compromised account based on the common credential.
